(19) United States
(12) Patent Application Publication
(10) Pub. No.: US 2019/0220802 A1
(43) Pub. Date: Jul. 18, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kazunori HORIKIRI, Kanagawa (JP)

(73) Assignee: FUJI XEROX CO., LTD., Tokyo (JP)

(21) Appl. No.: 16/240,796

(22) Filed: Jan. 7, 2019

(30) Foreign Application Priority Data
Jan. 17, 2018 (JP) 2018-005532

(51) Int. Cl. G06Q 10/06; G06F 17/24; G06Q 10/10

(52) U.S. Cl. CPC G06Q 10/063118; G06Q 10/109; G06F 17/241

(57) ABSTRACT

An information processing apparatus includes a type assignment unit. The type assignment unit assigns to a sticky note attachable to a board a problem type indicating that content of the sticky note is a problem.

### CROSS-REFERENCE TO RELATED APPLICATIONS

This application is based on and claims priority under 35 USC 119 from Japanese Patent Application No. 2018-005532 filed Jan. 17, 2018.

### BACKGROUND

### (i) Technical Field

The present disclosure relates to an information processing apparatus and a non-transitory computer readable medium.

### (ii) Related Art

Japanese Unexamined Patent Application Publication No. 2010-066868 discloses a system for, in order to create an electronic sticky note with a clarified relationship with an electronic file to achieve easy-to-use attachment of electronic sticky notes, attaching an electronic sticky note to an application currently in operation or to a file opened in the application. Upon receipt of a window message of the application currently in operation by using a system hook, the system obtains identification information of the application or the related file to generate a list of electronic sticky note targets, and, accordingly, creates and saves an electronic sticky note including identification information of a desired application or the related file. When an electronic sticky note is replaced with another electronic sticky note, the electronic sticky notes can be displayed or hidden in synchronization with display or hiding of files.

Japanese Patent No. 5704508 discloses an electronic sticky note generation and display program for, in order to change the displayed position of an electronic sticky note in accordance with a change in the layout or structure of the content of a web page, causing a computer to execute the steps of estimating, based on position information indicating the location of content of a web page in which the attachment of an electronic sticky note is specified, a location that is most similar to the location in which the electronic sticky note is to be applied from within the web page, and updating a source of the web page so that the electronic sticky note is displayed in the estimated location. In the electronic sticky note generation and display program, the position information includes a tag and an attribute of the location of the content in which the attachment of the electronic sticky note is specified, and the content in the tag. The location that is most similar to the location in which the electronic sticky note is to be applied is a location that most matches it in terms of the tag, the attribute, and the content in the tag.

### SUMMARY

In some cases, meetings are held in which problems are extracted or solutions to problems are extracted. In the meetings, sticky notes indicating problems or solutions are attached to boards.

Since it is difficult to assign a type to each sticky note, for example, participants in the meetings do not identify problems, solutions, or any other content unless they read the content of the sticky notes on the board.

Aspects of non-limiting embodiments of the present disclosure relate to an information processing apparatus and a non-transitory computer readable medium capable of assigning a problem type to a sticky note whose content is a problem.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a type assignment unit. The type assignment unit assigns to a sticky note attachable to a board a problem type indicating that content of the sticky note is a problem.

### BRIEF DESCRIPTION OF THE DRAWINGS

An exemplary embodiment of the present disclosure will be described in detail based on the following figures, wherein:

FIG. 1 is a conceptual module configuration diagram illustrating an example configuration of an information processing apparatus according to the exemplary embodiment;

FIG. 2 illustrates an example configuration of an electronic sticky note system according to the exemplary embodiment;

FIGS. 3A to 3C illustrate an example usage of electronic sticky note terminals and information processing apparatuses in a conference room or the like according to the exemplary embodiment;

FIG. 4 illustrates an example data structure of a meeting information table;

FIG. 5 illustrates an example data structure of a board information table;

FIG. 6 illustrates an example data structure of a message sticky note representation board table;

FIG. 7 illustrates an example data structure of a user area table;

FIG. 8 illustrates an example data structure of a sticky note information table;

FIG. 9 illustrates an example data structure of a job sticky note management table;

FIG. 10 illustrates an example tree structure of problems and jobs;

FIG. 11 is a flowchart illustrating an example process according to the exemplary embodiment;

FIG. 12 is a flowchart illustrating an example process according to the exemplary embodiment;

FIG. 13 is a flowchart illustrating an example process according to the exemplary embodiment;

FIG. 14 is a flowchart illustrating an example process according to the exemplary embodiment;

FIG. 15 illustrates an example process according to the exemplary embodiment;

FIG. 16 illustrates an example process according to the exemplary embodiment;

FIG. 17 illustrates an example process according to the exemplary embodiment;

FIG. 18 illustrates an example process according to the exemplary embodiment;

FIG. 19 illustrates an example process according to the exemplary embodiment;

FIG. 20 illustrates an example process according to the exemplary embodiment;

FIG. 21 illustrates an example process according to the exemplary embodiment;

FIG. 22 illustrates an example process according to the exemplary embodiment;

FIG. 23 illustrates an example process according to the exemplary embodiment;

FIG. 24 illustrates an example process according to the exemplary embodiment;

FIG. 25 illustrates an example process according to the exemplary embodiment;

FIG. 26 illustrates an example process according to the exemplary embodiment; and

FIG. 27 is a block diagram illustrating an example hardware configuration of a computer according to the exemplary embodiment.

### DETAILED DESCRIPTION

An exemplary embodiment of the present disclosure will be described with reference to the drawings.

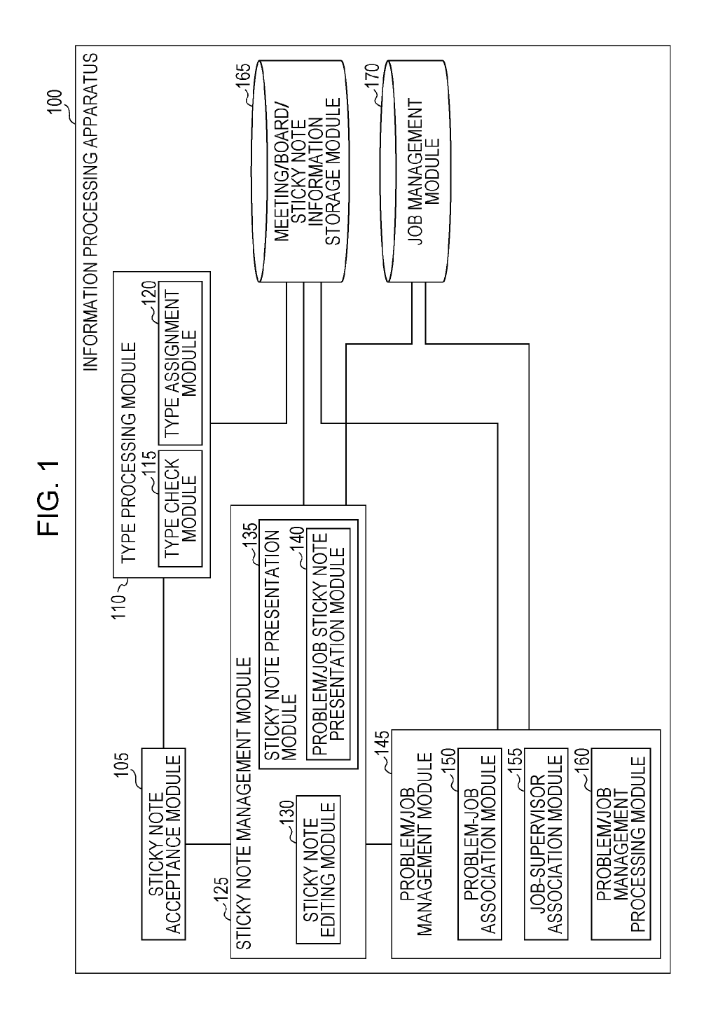

FIG. 1 is a conceptual module configuration diagram illustrating an example configuration of an information processing apparatus according to this exemplary embodiment.

The term “module” generally refers to a logically separable component such as a software (computer program) or hardware component. Thus, each module in this exemplary embodiment refers not only to a module in a computer program but also to a module in a hardware configuration. Accordingly, this exemplary embodiment is also directed to a computer program for causing a computer to function as these modules (i.e., a program for causing the computer to execute the respective procedures, a program for causing the computer to function as the respective units, or a program for causing the computer to implement the respective functions), as well as to a system and a method. While the expressions “store data” and “data is stored” and their equivalent expressions are used for convenience of description, such expressions have a meaning of making a storage device store data or controlling a storage device to store data if an exemplary embodiment is directed to a computer program. While each module may be given a single function, each module may be constituted by a single program or a plurality of modules may be constituted by a single program in actual implementation. Conversely, a single module may be constituted by a plurality of programs. In addition, a plurality of modules may be executed by a single computer, or a single module may be executed by a plurality of computers in a distributed or parallel environment. As an alternative, a single module may include another module. In the following, the term “connection” refers not only to a physical connection but also to a logical connection (such as exchanging of data, sending instructions, a reference relationship between data, and login). The term “predetermined” refers to a state in which certain information is determined before intended processing is to be performed, and is used to include not only a state in which such information is determined at a time point prior to the commencement of processing according to this exemplary embodiment but also a state in which the information is determined at a time point prior to intended processing even after the processing according to this exemplary embodiment has commenced, depending on the condition or the state at that time or depending on the condition or the state until that time. When there is a plurality of “predetermined values”, the values may be different or two or more (or all) of the values may be identical. A description having a meaning of “if A, then B” is used to mean: “it is determined whether or not A, and B if it is determined that A” unless the determination of whether or not A is required. Further, when elements are enumerated, such as “A, B, and C”, the enumerated elements are examples unless otherwise stated, and the enumeration is used to also include selection of only one of them (e.g., only A).

Furthermore, the term “system”, “apparatus”, or “device” is used to include a configuration in which a plurality of computers, hardware components, apparatuses, devices, or other suitable elements are connected to each other via a communication means such as a network (including one-to-one communication connections), and what is implemented by a single computer, hardware component, apparatus, device, or suitable element. The terms “apparatus”, “device”, and “system” are used synonymously. It is to be understood that the term “system” does not include what is merely a social “mechanism” (social system), which is a kind of artificial arrangement.

Moreover, target information is read from a storage device for each processing operation that is to be performed by an individual module or, if a plurality of processing operations are to be performed within a module, for each of the plurality of processing operations. After the processing is performed, the result of the processing is written to the storage device. Thus, the reading of information from the storage device before the processing of the information is to be performed and the writing of information to the storage device after the processing of the information has been performed will not be described in some cases. Examples of the storage device used here may include a hard disk, a random access memory (RAM), an external storage medium, a storage device connected via a communication line, and a register within a central processing unit (CPU).

An information processing apparatus 100 (electronic sticky note control apparatus) according to this exemplary embodiment performs processes concerning a board and sticky notes (also referred to as electronic sticky notes or electronic cards) that are used during a meeting. As in an example illustrated in FIG. 1, the information processing apparatus 100 includes a sticky note acceptance module 105, a type processing module 110, a sticky note management module 125, a problem/job management module 145, a meeting/board/sticky note information storage module 165, and a job management module 170. The meeting may be a gathering of a plurality of people for discussion, and examples of the meeting include a conference, a workshop, an idea exchange meeting, a seminar, a brainstorming meeting, a discussion, an assembly, and any other suitable gathering. This exemplary embodiment provides an electronic sticky note system (also referred to as an electronic white board, for example) that uses digital sticky notes and a board.

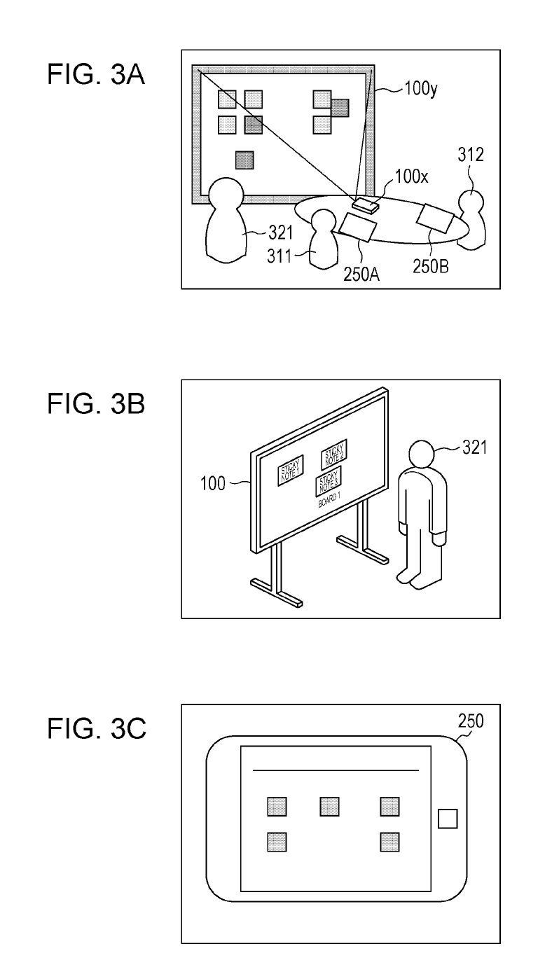

Specifically, the information processing apparatus 100 is used during a meeting conducted by one or more facilitators (typically, a single facilitator) and a plurality of participants using sticky notes. The participants use participant terminals, which are implemented as electronic sticky note terminals 250, to create sticky notes on which ideas and so on are written. Typically, as in an example illustrated in FIG. 3A, the electronic sticky note terminals 250 include an electronic sticky note terminal 250A, an electronic sticky note terminal 250B, and so on, each of which is held by one of the participants. The electronic sticky note terminal 250A, the electronic sticky note terminal 250B, and so on are hereinafter collectively referred to as the electronic sticky note terminals 250. The information processing apparatus 100 receives sticky notes from the electronic sticky note terminals 250 and attaches the sticky notes to a board (or a background). The facilitator uses a shared screen, which is a display device of the information processing apparatus 100, to decide or change the positions of the sticky notes on the board, to combine the sticky notes (or associate a first sticky note with a second sticky note or group the sticky notes, for example), or to create sticky note information, for example, and moves the meeting forward. In this exemplary embodiment, the facilitator is included in the participants. The sticky notes are also referred to as messages.

The sticky note acceptance module 105 is connected to the type processing module 110 and the sticky note management module 125. The sticky note acceptance module 105 accepts sticky notes. The sticky note acceptance module 105 may accept sticky notes from the electronic sticky note terminals 250, accept a sticky note created by a user (typically, the facilitator) operating the information processing apparatus 100, or accept sticky notes stored in a board/sticky note information storage device 294 or the like.

Then, the sticky note acceptance module 105 transfers the sticky notes to the type processing module 110 and the sticky note management module 125.

The type processing module 110 includes a type check module 115 and a type assignment module 120, and is connected to the sticky note acceptance module 105 and the meeting/board/sticky note information storage module 165. The type processing module 110 performs processes concerning the types of the sticky notes accepted by the sticky note acceptance module 105.

The type check module 115 checks whether each of the sticky notes has a type. Each type may be assigned to a sticky note after the sticky note has been created (e.g., after content has been written on the sticky note), or a sticky note to which a type has been assigned may be created. In the latter case, each of the sticky notes is blank.

The type assignment module 120 assigns to a sticky note attachable to the board a type indicating the kind of the content of the sticky note. The type may be assigned in response to an operation performed by a user or in accordance with the content of the sticky note which has been determined. Examples of assignment of a type in response to an operation performed by a user include displaying a menu having a list of types on each sticky note and prompting the user to select one of the types. Examples of assignment of a type in accordance with the content of each sticky note include assigning a problem type to a sticky note if the word “problem” or a similar expression is written on the sticky note and assigning a solution type to a sticky note if the word “solution”, “job”, or “action” or a similar expression is written on the sticky note. Other examples of assignment of a type in accordance with the content of each sticky note include performing machine learning in advance by using teacher data (sticky notes already assigned types) to associate the content written on the sticky note with a type. Further, a machine-learned model may be used to assign a type to each sticky note.

The type assignment module 120 is capable of assigning to a sticky note attachable to the board a problem type indicating that the content of the sticky note is a problem.

The type assignment module 120 is further capable of assigning to a sticky note a solution type, other than the problem type, indicating that the content of the sticky note is a solution to a problem. The solution type is also referred to as an action or a job, for example (hereinafter referred to also as a job).

The type assignment module 120 is further capable of assigning to a sticky note a normal type, other than the problem type and the solution type, indicating that the content of the sticky note is not a problem or a solution. The normal type is different from the problem type and the solution type.

The sticky note management module 125 includes a sticky note editing module 130 and a sticky note presentation module 135, and is connected to the sticky note acceptance module 105, the problem/job management module 145, the meeting/board/sticky note information storage module 165, and the job management module 170. The sticky note management module 125 manages sticky notes.

The sticky note editing module 130 edits the content of each sticky note in accordance with an operation performed by a user.

The sticky note presentation module 135 includes a problem/job sticky note presentation module 140. The sticky note presentation module 135 presents sticky notes on the board.

The sticky note presentation module 135 may present sticky notes in such a manner that the sticky notes are placed on the board in chronological order. The term “chronological order” refers to the order in which the sticky notes were created, or the order in which the sticky notes were corrected (for a sticky note not corrected, the time when the sticky note was created is identified as the time of correction), by way of example but limitation. The sticky note presentation module 135 may present sticky notes for each user, who is a participant in the meeting, in chronological order. For example, the board may include areas, each of which is defined for a user, such that sticky notes are attached to the areas using a common timeline.

Further, the sticky note presentation module 135 may present sticky notes of the problem type, sticky notes of the solution type, and sticky notes of the normal type in a different manner (such as using different colors, shapes, or frame line thicknesses) to allow the participants in the meeting to identify a difference among them.

The problem/job sticky note presentation module 140 presents sticky notes of the problem type and sticky notes of the solution type, which are attached to the board.

Further, when a sticky note attached to the board has the problem type, the problem/job sticky note presentation module 140 may present a sign for the sticky note on the board, indicating that the sticky note has been checked by a user having an area on the board when the user is participating in a meeting during which the board is used. A process for determining whether a user has checked a sticky note of the problem type is performed by a problem/job management processing module 160.

The problem/job sticky note presentation module 140 may present the signs in accordance with chronological order.

The problem/job management module 145 includes a problem-job association module 150, a job-supervisor association module 155, and the problem/job management processing module 160, and is connected to the sticky note management module 125, the meeting/board/sticky note information storage module 165, and the job management module 170. The problem/job management module 145 manages problems and solutions to the problems.

The problem-job association module 150 associates (or links) each problem with a solution to the problem. For example, the problem-job association module 150 associates a sticky note of the problem type with a sticky note of the solution type in accordance with an operation performed by a user. Specifically, the problem-job association module 150 may associate a sticky note of the problem type with a sticky note that overlaps the sticky note of the problem type, as a sticky note of the solution type.

The job-supervisor association module 155 associates (or links) a solution written on a sticky note of the solution type with a user who supervises the solution.

When a sticky note attached to the board has a solution type, in response to the movement of the sticky note to an area defined for a user on the board, the job-supervisor association module 155 may cause the user to supervise the solution written on the sticky note.

When the sticky note is moved to an area for a different user (B), the job-supervisor association module 155 may obtain permission from the different user (B).

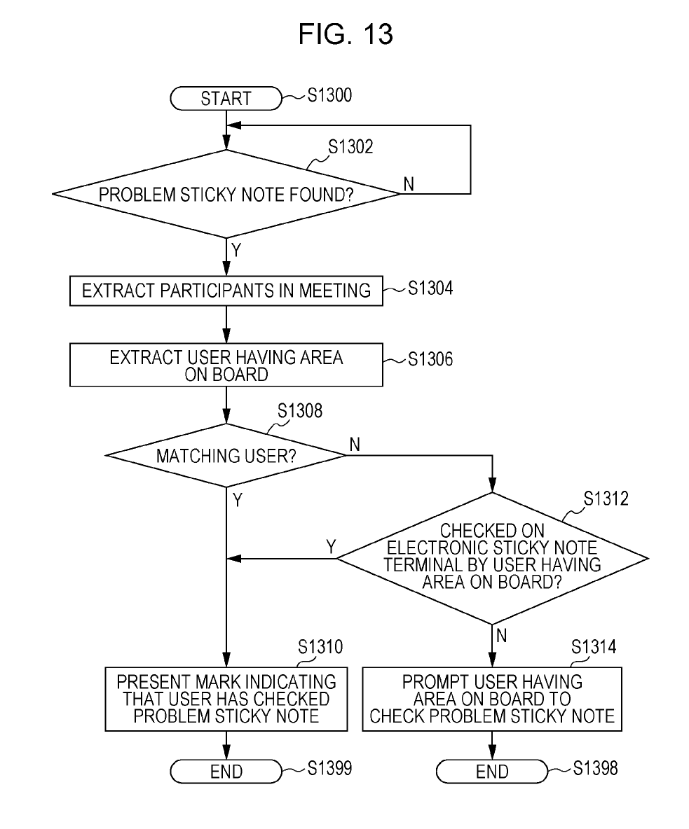

The problem/job management processing module 160 prompts the participants to check a sticky note of the problem type. A sign indicating the result of the check process performed by the problem/job management processing module 160 is presented by the problem/job sticky note presentation module 140. A specific example process will be described below with reference to FIG. 13.

Further, the problem/job management processing module 160 manages sticky notes of the problem type and sticky notes of the solution type by using a tree structure.

Specifically, a tree structure is created in the following way.

(1) When a problem is broken down into multiple smaller problems, a sticky note indicating the original problem is identified as a parent and sticky notes indicating the smaller problems are identified as children.

(2) When a solution is divided into multiple smaller solutions, a sticky note indicating the original solution is identified as a parent and sticky notes indicating the smaller solutions are identified as children.

In a repeated cycle of extraction of a problem and extraction of a solution to the problem, in some cases,

(3) when a problem is extracted and a solution to solve the problem is created, a sticky note of the problem type is identified as a parent and a sticky note of the solution type to solve the problem is identified as a child, and

(4) when a new problem is extracted during the implementation of the solution, the sticky note of the solution type is identified as a parent and a sticky note of the problem type indicating the extracted new problem is identified as a child.

The meeting/board/sticky note information storage module 165 is connected to the type processing module 110, the sticky note management module 125, and the problem/job management module 145. The meeting/board/sticky note information storage module 165 stores information concerning a meeting, a board used during the meeting, and sticky notes attached to the board. For example, the meeting/board/sticky note information storage module 165 stores a meeting information table 400, a board information table 500, a message sticky note representation board table 600, a user area table 700, and a sticky note information table 800.

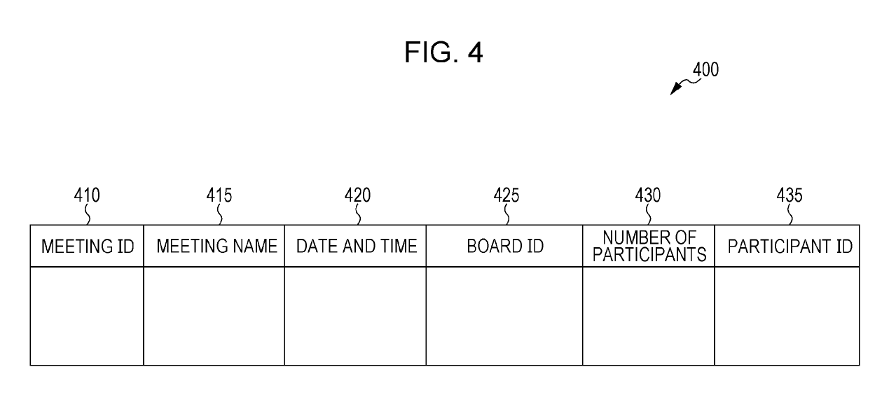

FIG. 4 illustrates an example data structure of the meeting information table 400. The meeting information table 400 is stored in the meeting/board/sticky note information storage module 165. The meeting information table 400 has a “meeting ID” column 410, a “meeting name” column 415, a “date and time” column 420, a “board ID” column 425, a “number of participants” column 430, and a “participant ID” column 435. The “meeting ID” column 410 stores information (meeting identification (ID)) for uniquely identifying a meeting in this exemplary embodiment. The “meeting name” column 415 stores the name of the meeting. The “date and time” column 420 stores the date and time or period when the meeting is held (in year, month, day of the month, hours, minutes, and seconds or a combination thereof). The “board ID” column 425 stores information (board ID) for uniquely identifying a board used during the meeting in this exemplary embodiment. The “number of participants” column 430 stores the number of participants in the meeting. The “participant ID” column 435 stores information (a list of participant IDs) for uniquely identifying the participants in this exemplary embodiment.

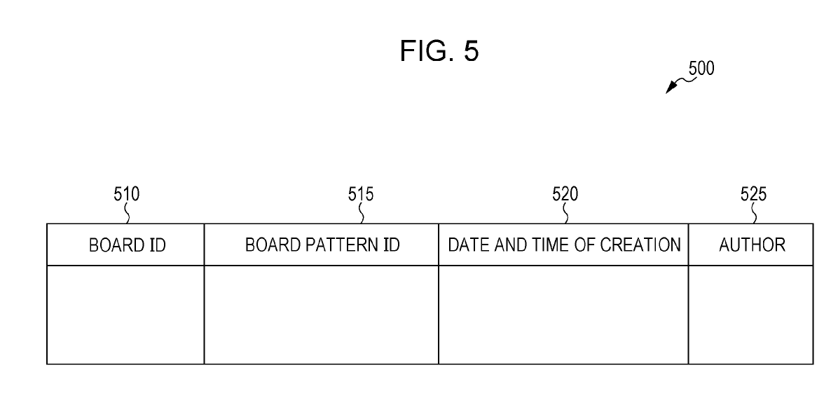

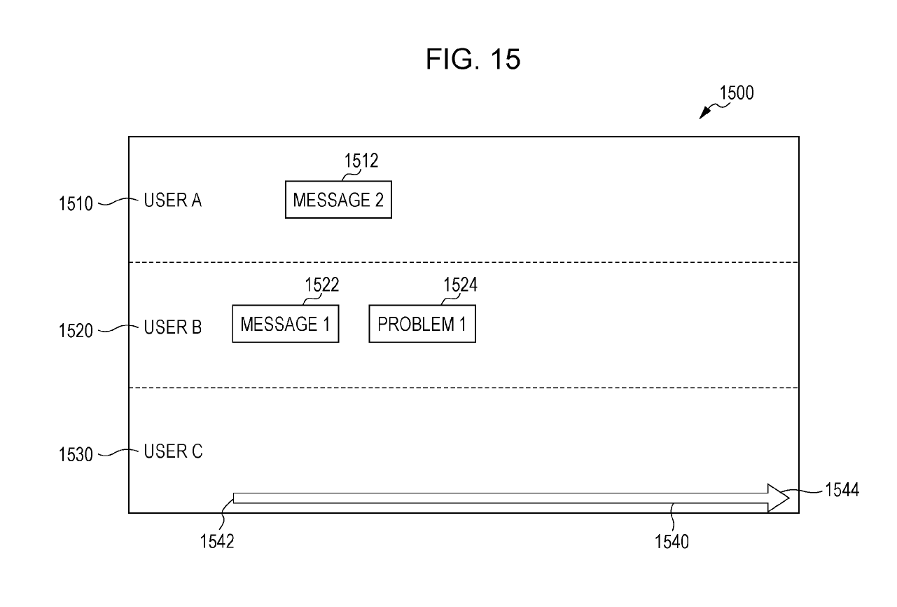

FIG. 5 illustrates an example data structure of the board information table 500. The board information table 500 is stored in the meeting/board/sticky note information storage module 165. The board information table 500 has a “board ID” column 510, a “board pattern ID” column 515, a “date and time of creation” column 520, and an “author” column 525. The “board ID” column 510 stores the ID of a board. The “board pattern ID” column 515 stores the ID of a board pattern that forms a background. Examples of the board pattern include a plain white and a blank table. Other examples of the board pattern may include a board pattern for task management. Specifically, areas are each determined in advance for a meeting participant (or a person who may be a supervisor of a solution) such that the names or icons of avatars of the meeting participants are written in the areas. At the time point when a participant in the meeting is determined, the name or icon of the participant may be written in each of the areas. In addition, a pattern in which the board is separated into areas for the participants (a message sticky note representation board) may be prepared, such as a pattern depicted in an example illustrated in FIG. 15 described below in which one of the areas is allocated to a supervisor, with the horizontal axis representing the date and time when a sticky note is applied (or created or corrected, for example) and the vertical axis representing each supervisor. The message sticky note representation board is managed using the message sticky note representation board table 600 and the user area table 700. The “date and time of creation” column 520 stores the date and time of creation of the board. The “author” column 525 stores the author of the board.

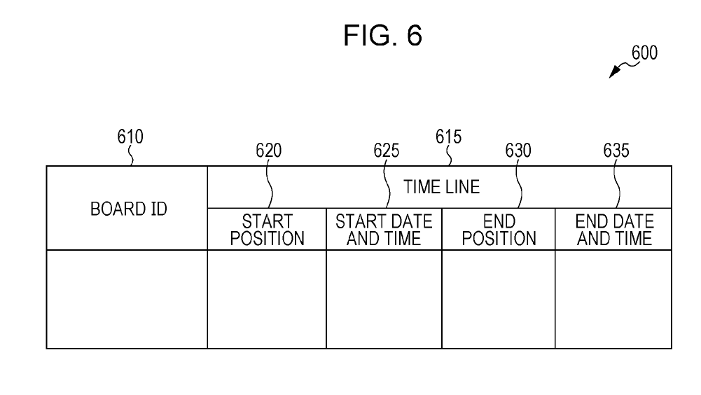

FIG. 6 illustrates an example data structure of the message sticky note representation board table 600. The message sticky note representation board table 600 is stored in the meeting/board/sticky note information storage module 165. The message sticky note representation board table 600 has a “board ID” column 610 and a “timeline” column 615. The “timeline” column 615 has a “start position” column 620, a “start date and time” column 625, an “end position” column 630, and an “end date and time” column 635. The “board ID” column 610 stores the ID of a board. The “timeline” column 615 stores the timeline on the board. The “start position” column 620 stores the position at which the timeline starts. The “start date and time” column 625 stores the date and time of the start of the timeline. The “end position” column 630 stores the position at which the timeline ends. The “end date and time” column 635 stores the date and time of the end of the timeline.

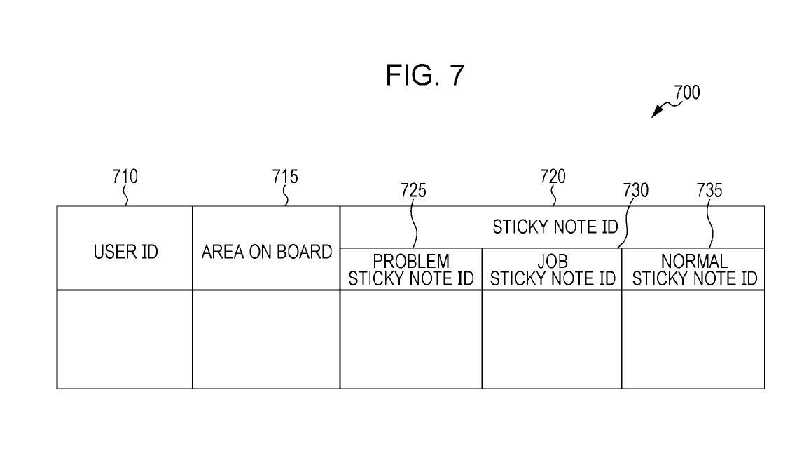

FIG. 7 illustrates an example data structure of the user area table 700. The user area table 700 is stored in the meeting/board/sticky note information storage module 165. The user area table 700 has a “user ID” column 710, an “area on board” column 715, and a “sticky note ID” column 720. The “sticky note ID” column 720 has a “problem sticky note ID” column 725, a “job sticky note ID” column 730, and a “normal sticky note ID” column 735. The “user ID” column 710 stores information (user ID) for uniquely identifying a user in this exemplary embodiment. The “area on board” column 715 stores an area for the user on the board. For example, each area may be a rectangular area, and sets of coordinates of opposite corners of the rectangular area on the board may be stored. The “sticky note ID” column 720 stores information (sticky note ID) for uniquely identifying a sticky note attached to the area in this exemplary embodiment. The “problem sticky note ID” column 725 stores the ID of a sticky note of the problem type attached to the area. The “job sticky note ID” column 730 stores the ID of a sticky note of the solution type (job sticky note ID) attached to the area. The “normal sticky note ID” column 735 stores the ID of a sticky note of the normal type attached to the area.

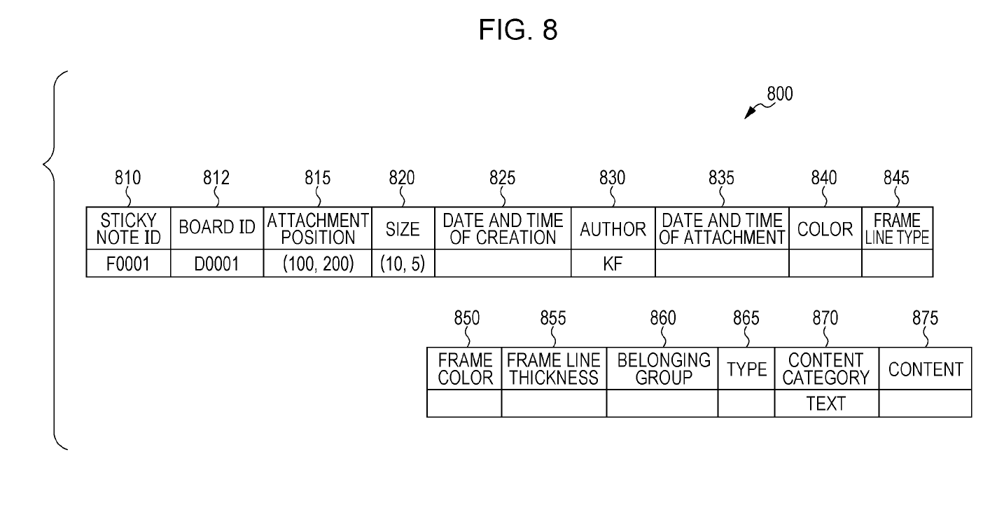

FIG. 8 illustrates an example data structure of the sticky note information table 800. The sticky note information table 800 is stored in the meeting/board/sticky note information storage module 165. The sticky note information table 800 has a “sticky note ID” column 810, a “board ID” column 812, an “attachment position” column 815, a “size” column 820, a “date and time of creation” column 825, an “author” column 830, a “date and time of attachment” column 835, a “color” column 840, a “frame line type” column 845, a “frame color” column 850, a “frame line thickness” column 855, a “belonging group” column 860, a “type” column 865, a “content category” column 870, and a “content” column 875. The “sticky note ID” column 810 stores the ID of a sticky note. The “board ID” column 812 stores the ID of a board to which the sticky note is attached. The “attachment position” column 815 stores the position at which the sticky note is attached (such as the position of the center or the upper left end of the sticky note). That is, the “attachment position” column 815 stores an attachment position on the board. The position is represented by, for example, coordinates in the XY coordinate system on the board. The “size” column 820 stores the size of the sticky note. For example, when a sticky note to be presented is rectangular, the width and height of the sticky note are stored. The “date and time of creation” column 825 stores the date and time when the sticky note is created (in year, month, day of the month, hours, minutes, and seconds or a combination thereof). The “author” column 830 stores information (author ID) for identifying the author of the sticky note. Alternatively, the “author” column 830 may store information for identifying an information processing apparatus used to create the sticky note (the device ID of the electronic sticky note terminal 250 or the information processing apparatus 100). The “date and time of attachment” column 835 stores the date and time when the sticky note is attached to the board. The “color” column 840 stores the display color of the sticky note. The “frame line type” column 845 stores the line type (such as a solid line, a dotted line, a broken line, a wavy line, or double lines) of a frame representing the display area of the sticky note. The “frame color” column 850 stores the color of the frame representing the display area of the sticky note. The “frame line thickness” column 855 stores the thickness of the lines of the frame representing the display area of the sticky note. The “belonging group” column 860 stores information concerning a group to which the sticky note belongs. For example, the “belonging group” column 860 may store information indicating whether the sticky note belongs to a group. If the sticky note belongs to a group, a group ID, the sticky note IDs of the other sticky notes belonging to the group, or the like may be stored. The “type” column 865 stores the type of the sticky note. Specific examples of the type include a problem type, a solution type, and a normal type. The “content category” column 870 stores the category of the content of the sticky note (text information, vector data indicating handwritten characters, a figure, or the like, audio information, still image information indicating a photograph or the like, moving image information, or information indicating a combination thereof). The “content” column 875 stores the content written on the sticky note.

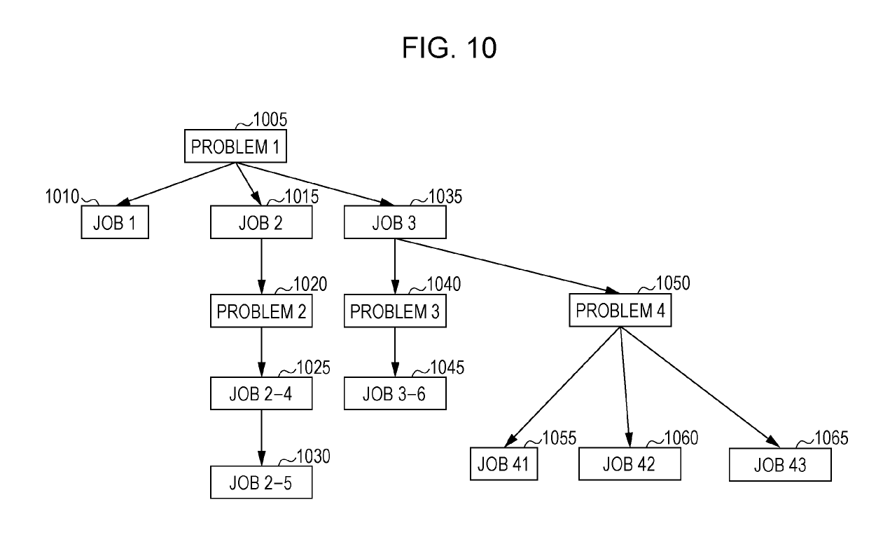

Sticky notes of the problem type and sticky notes of the solution type form a tree structure. For example, a tree structure illustrated in FIG. 10 is used.

A “job 1” sticky note 1010, a “job 2” sticky note 1015, and a “job 3” sticky note 1035 are subordinate to a “problem 1” sticky note 1005. A “problem 2” sticky note 1020 is subordinate to the “job 2” sticky note 1015. A “job 2-4” sticky note 1025 is subordinate to the “problem 2” sticky note 1020. A “job 2-5” sticky note 1030 is subordinate to the “job 2-4” sticky note 1025. A “problem 3” sticky note 1040 and a “problem 4” sticky note 1050 are subordinate to the “job 3” sticky note 1035. A “job 3-6” sticky note 1045 is subordinate to the “problem 3” sticky note 1040. A “job 41” sticky note 1055, a “job 42” sticky note 1060, and a “job 43” sticky note 1065 are subordinate to the “problem 4” sticky note 1050.

The example illustrated in FIG. 10 mainly indicates a repeated cycle of extraction of a problem and extraction of a solution to the problem. Specifically, a relationship between the “problem 1” sticky note 1005 and each of the “job 1” sticky note 1010, the “job 2” sticky note 1015, and the “job 3” sticky note 1035 is established when a solution to solve a problem is created. A relationship between the “job 3” sticky note 1035 and each of the “problem 3” sticky note 1040 and the “problem 4” sticky note 1050 is established when a new problem is extracted during the implementation of a solution. A relationship between the “job 2-4” sticky note 1025 and the “job 2-5” sticky note 1030 is established when a solution is divided into a smaller solution.

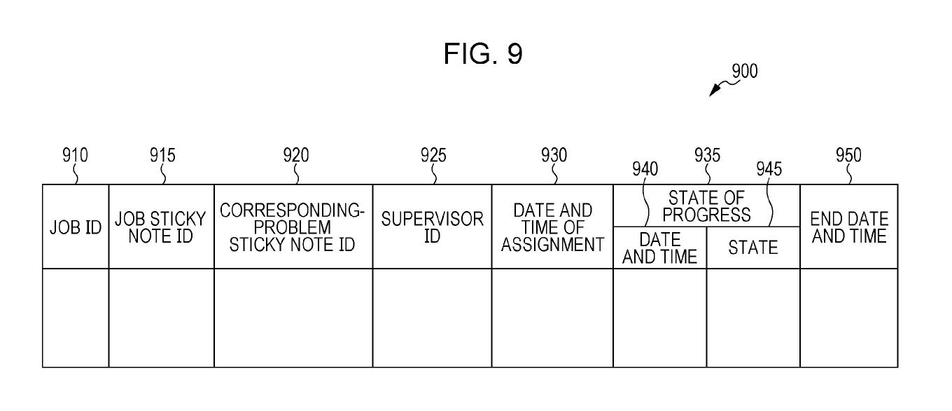

The job management module 170 is connected to the sticky note management module 125 and the problem/job management module 145. The job management module 170 stores information concerning solutions (jobs). For example, the job management module 170 stores a job sticky note management table 900. FIG. 9 illustrates an example data structure of the job sticky note management table 900. The job sticky note management table 900 is stored in the job management module 170. The job sticky note management table 900 has a “job ID” column 910, a “job sticky note ID” column 915, a “corresponding-problem sticky note ID” column 920, a “supervisor ID” column 925, a “date and time of assignment” column 930, a “state of progress” column 935, and an “end date and time” column 950. The “state of progress” column 935 has a “date and time” column 940 and a “state” column 945. The “job ID” column 910 stores information (job ID) for uniquely identifying a job, which is a solution, in this exemplary embodiment. The “job sticky note ID” column 915 stores the ID of a job sticky note on which the job is written. The “corresponding-problem sticky note ID” column 920 stores the ID of a sticky note on which the problem corresponding to the job is written. The “supervisor ID” column 925 stores information (supervisor ID) for uniquely identifying a supervisor who is responsible for the job in this exemplary embodiment. The “date and time of assignment” column 930 stores the date and time when the job is assigned. The “state of progress” column 935 stores a state indicating how the job progresses. The “date and time” column 940 stores a date and time. The “state” column 945 stores the state of the job at that date and time. The “end date and time” column 950 stores the end date and time of the job.

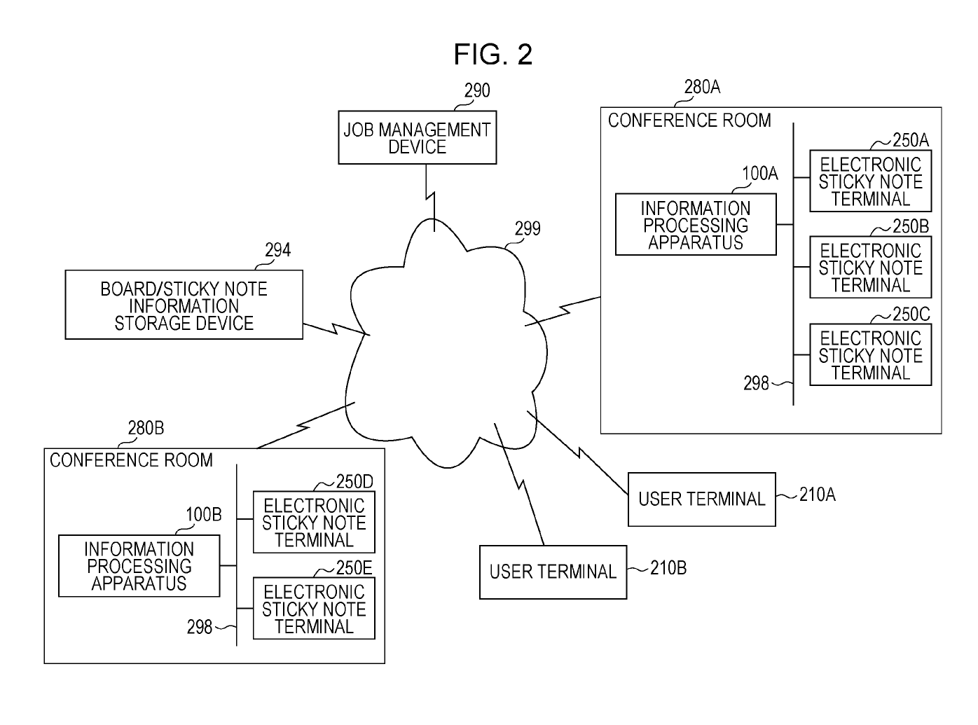

FIG. 2 illustrates an example configuration of an electronic sticky note system according to this exemplary embodiment. The information processing apparatus 100 typically includes a display device having a large screen and is typically operated by the facilitator. The screen of the display device has a size visible to all the participants. Each of the electronic sticky note terminals 250 is operated by a participant in the meeting. Typically, each participant possesses one electronic sticky note terminal 250. Examples of the electronic sticky note terminals 250 include tablet terminals.

In the example illustrated in FIG. 2, in a conference room 280A, an information processing apparatus 100A, an electronic sticky note terminal 250A, an electronic sticky note terminal 250B, and an electronic sticky note terminal 250C are placed, and a meeting is held. The information processing apparatus 100A, the electronic sticky note terminal 250A, the electronic sticky note terminal 250B, and the electronic sticky note terminal 250C are connected to one another via a communication line 298. The communication line 298 may be a wireless or wired line or a combination thereof, and may be, for example, a communication infrastructure such as the Internet or an intranet.

In a conference room 280B, an information processing apparatus 100B, an electronic sticky note terminal 250D, and an electronic sticky note terminal 2503 are placed, and a meeting different from that in the conference room 280A is held. The information processing apparatus 100B, the electronic sticky note terminal 250D, and the electronic sticky note terminal 250E are connected to one another via the communication line 298.

A user terminal 210A, a user terminal 210B, a job management device 290, the board/sticky note information storage device 294, the devices in the conference room 280A, and the devices in the conference room 280B are connected to one another via a communication line 299. The communication line 299 may be a wireless or wired line or a combination thereof, and may be, for example, a communication infrastructure such as the Internet or an intranet. The functions achieved by the job management device 290 and the board/sticky note information storage device 294 may be implemented as cloud services.

The job management device 290 stores information concerning solutions (corresponding to the information in the job management module 170). The information processing apparatuses 100A and 100B (hereinafter referred to collectively as the information processing apparatuses 100) may perform processes using the job management device 290. In this case, information concerning solutions, which is stored in the job management device 290, may be shared by the information processing apparatuses 100. That is, information concerning solutions managed by the information processing apparatus 100A may be available to the information processing apparatus 100B.

Further, the job management device 290 manages the states of solutions, or jobs. For example, the job management device 290 may have functions equivalent to those of a task management processing device (also referred to as a To Do management device or the like). Specifically, the job management device 290 uses the content (solution) written on a solution sticky note as a To Do item, sets a supervisor (a user associated with the area to which the sticky note is attached), an expiry, and so on, and manages the progress of the solution. If the progress changes, the job management device 290 transmits the content to the information processing apparatuses 100. In particular, when the information processing apparatuses 100 receive a completion notification, the job management device 290 may delete the sticky note indicating the solution from the display device.

The board/sticky note information storage device 294 stores information concerning the board and the sticky notes (corresponding to the information stored in the meeting/board/sticky note information storage module 165). Each of the information processing apparatuses 100 may perform processes using the board/sticky note information storage device 294. In this case, the information concerning the board and the sticky notes, which is stored in the board/sticky note information storage device 294, may be shared by the information processing apparatuses 100. That is, information concerning the board and sticky notes, which is managed by the information processing apparatus 100A, may be available to the information processing apparatus 100B.

FIGS. 3A to 3C illustrate an example usage of the electronic sticky note terminals 250 and the information processing apparatuses 100 according to this exemplary embodiment in a conference room or the like (such as the conference room 280A or 280B).

As in an example illustrated in FIG. 3A, participants 311 and 312 and a facilitator 321 gather in a conference room or the like. The participant 311 uses the electronic sticky note terminal 250A, and the participant 312 uses the electronic sticky note terminal 250B. Typically, each participant is given a single terminal apparatus (such as the electronic sticky note terminal 250A). The terminal apparatus is a tablet terminal having a size as large as a notebook (such as A4 or B5 size or 7 to 10 inches), such as the electronic sticky note terminal 250 depicted in the example illustrated in FIG. 3C, and is operated with a finger, a pen, or any other suitable tool. Each participant creates sticky note information indicating a sticky note on which text data, handwritten characters, a figure, or the like is written. The terminal apparatus is not limited to a tablet terminal and may be a personal computer (PC) (including a notebook PC) including a keyboard, a mouse, and so on.

An information processing apparatus 100x depicted in the example illustrated in FIG. 3A is a projector and displays a board and sticky notes. An information processing apparatus 100y is an electronic white board and accepts operations such as detecting the movement of a finger of the facilitator 321, a pen, or the like to attach a sticky note to the board (e.g., a table), moving a sticky note, and associating (grouping) sticky notes. For example, the information processing apparatus 100y is equipped with a pen. Upon detection of deviation of the pen from a predetermined pen holder (e.g., removal of the pen from the pen holder by the facilitator 321 to operate the information processing apparatus 100y) and detection of the position of the tip of the pen (such as a contact of the tip of the pen with the information processing apparatus 100y), the information processing apparatus 100y accepts an operation on the board and a sticky note. For example, each pen holder may be provided with a sensor (such as a sensor whose switch is turned on or off by the weight of the pen), and which pen among a plurality of pens (such as a black pen, a red pen, and a blue pen) is being used may be detected. Alternatively, the display screen of the information processing apparatus 100y may be implemented as a touch sensor which is configured to detect the position and pressure of a touch on the display screen. In this example, the on and off state of each pen are controlled by the pen holder. However, the pen holders are optional. Each pen may be used to directly control the on and off states of the pen. Colors may be changed by using, instead of the pen holders, a color palette prepared in a portion on the display screen. An intended color is touched with a pen (or a similar tool) to change a color. Alternatively, a pen may have a function (such as a button or a slider) for giving an instruction to change a color.

The information processing apparatus 100 may be an electronic board depicted in an example illustrated in FIG. 3B. An electronic board typically includes a display device having a large screen (at least larger than the screen of the display device of each of the electronic sticky note terminals 250). The display device is a touch panel and is configured to detect the position and pressure of a touch on the display screen. For example, the information processing apparatus 100 may have a screen as large as 80 inches, for example.

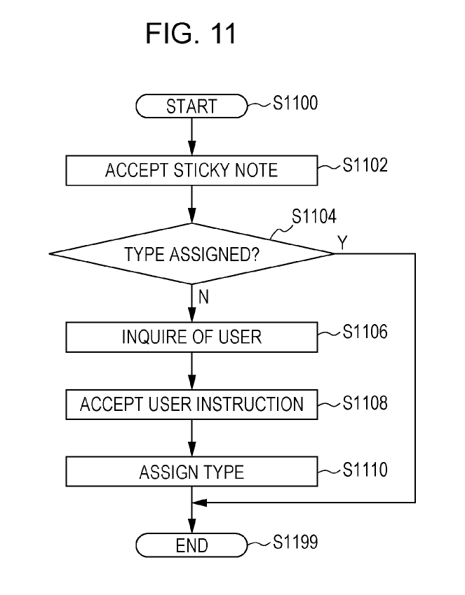

FIG. 11 is a flowchart illustrating an example process according to this exemplary embodiment. An example process for assigning a type is mainly illustrated. The process starts in step S1100.

In step S1102, the sticky note acceptance module 105 accepts a sticky note.

In step S1104, the type check module 115 determines whether the sticky note has a type. If the sticky note has a type, the process ends (step S1199). Otherwise, the process proceeds to step S1106. The determination of whether the sticky note has a type may be performed by checking the “type” column 865 of the sticky note information table 800 in the example illustrated in FIG. 8.

In step S1106, the type check module 115 inquires of the user about the type of the sticky note. That is, the type check module 115 requests the user to select a type to be assigned to the target sticky note.

In step S1108, the type check module 115 accepts an instruction given by the user. That is, the type of the sticky note is designated in accordance with an operation performed by the user.

In step S1110, the type assignment module 120 assigns the type accepted in step S1108 to the sticky note.

Instead of the processing of steps S1106 to S1110, the type assignment module 120 may assign the normal type to the sticky note by default.

During creation of a sticky note, a type may be assigned to the sticky note in accordance with an instruction given by the user. After the assignment of a type, the type may be changed in accordance with an instruction given by the user. Alternatively, a type may be assigned to a sticky note in accordance with the content written on the sticky note. A specific example has been described in the description of the type assignment module 120.

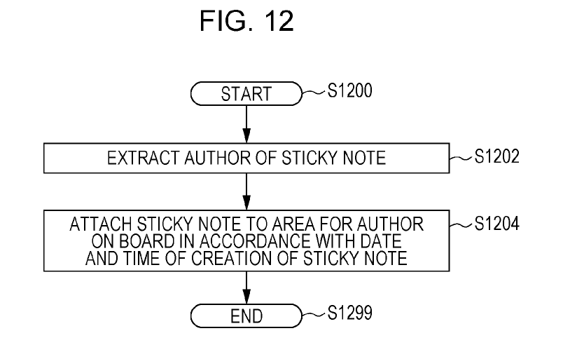

FIG. 12 is a flowchart illustrating an example process according to this exemplary embodiment. An example presentation process performed by the problem/job sticky note presentation module 140 is mainly illustrated. The process starts in step S1200.

In step S1202, the problem/job sticky note presentation module 140 extracts the author of a sticky note.

In step S1204, the problem/job sticky note presentation module 140 attaches the sticky note to the area defined for the author on the board in accordance with the date and time of creation of the sticky note. Specifically, the problem/job sticky note presentation module 140 attaches the sticky note to a user area on the board by using the “area on board” column 715 of the user area table 700 depicted in the example illustrated in FIG. 7, the message sticky note representation board table 600 depicted in the example illustrated in FIG. 6, and the “date and time of creation” column 825 and the “author” column 830 of the sticky note information table 800 depicted in the example illustrated in FIG. 8.

Then, the process ends (step S1299).

FIG. 13 is a flowchart illustrating an example process according to this exemplary embodiment. An example process performed by the problem/job management processing module 160 for prompting a user to check a sticky note of the problem type is mainly illustrated. In addition to users participating in the meeting, users not participating in the meeting are also targets. The process starts in step S1300.

In step S1302, the problem/job management processing module 160 determines whether the target board includes a sticky note of the problem type. If the board includes a sticky note of the problem type, the process proceeds to step S1304. Otherwise, the problem/job management processing module 160 waits for a problem sticky note to be found.

In step S1304, the problem/job management processing module 160 extracts participants in the meeting.

In step S1306, the problem/job management processing module 160 extracts a user having an area on the board.

In step S1308, the problem/job management processing module 160 determines whether there is a match between the participants in the meeting (extracted in step S1304) and the user having the area on the board (extracted in step S1306). If there is a match, the process proceeds to step S1310. Otherwise, the process proceeds to step S1312. When the process proceeds to step S1312, a user not participating in the meeting has an area on the board.

In step S1310, the problem/job management processing module 160 provides a mark for the sticky note of the problem type, indicating that the user has checked the sticky note of the problem type. That is, the user, who is participating in the meeting during which the board is being used, is viewing the sticky note of the problem type attached to the board. Then, the process ends (step S1399).

In step S1312, the problem/job management processing module 160 determines whether the user having the area on the board has checked the sticky note of the problem type on the electronic sticky note terminal 250. If the sticky note of the problem type has been checked, the process proceeds to step S1310. Otherwise, the process proceeds to step S1314.

In step S1314, the problem/job management processing module 160 prompts the user having the area on the board to check the sticky note of the problem type. For example, the problem/job management processing module 160 may notify the user of the content of the sticky note of the problem type by using a communication function or the like based on an electronic mail, a chat, or a social networking service (SNS). Then, the process ends (step S1398).

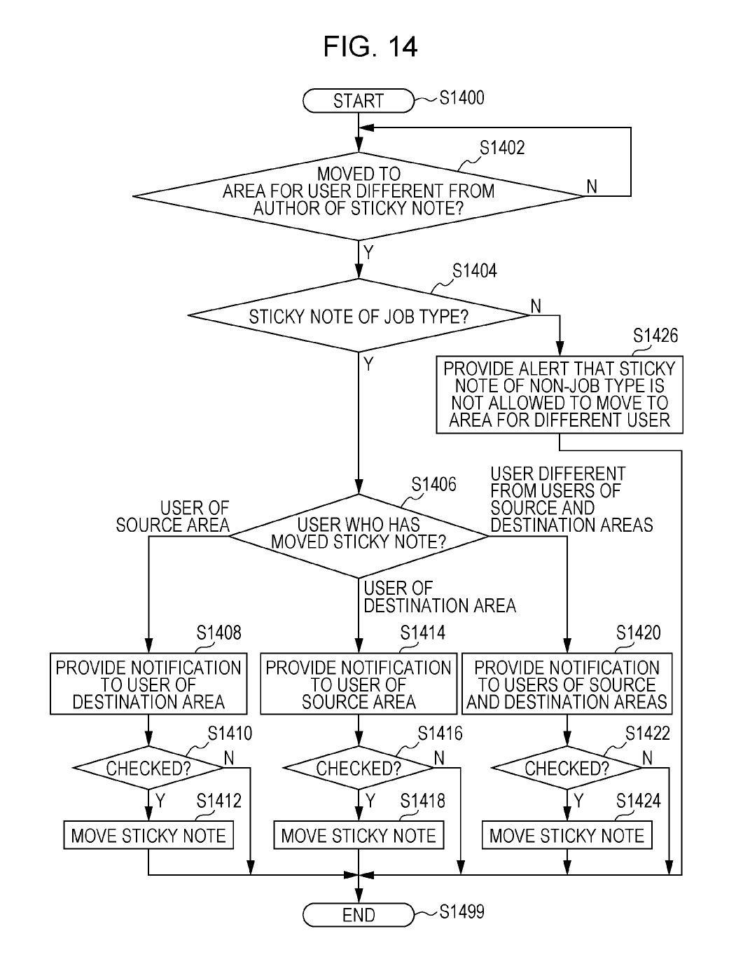

FIG. 14 is a flowchart illustrating an example process according to this exemplary embodiment. An example process performed by the job-supervisor association module 155 for causing the content of a sticky note of the solution type (a job, which is a solution) to be supervised by another user who is different from the author of the sticky note is mainly illustrated. The process starts in step S1400.

In step S1402, the job-supervisor association module 155 determines whether the sticky note has been moved to an area for a user different from the author of the sticky note. If the sticky note has been moved to an area for a different user, the process proceeds to step S1404. Otherwise, the job-supervisor association module 155 waits for the sticky note to be moved. If the user who has created the sticky note is responsible for the content of the sticky note (i.e., a solution), the process of step S1404 and the following steps need not be performed.

In step S1404, the job-supervisor association module 155 determines whether the type of the sticky note is a job (solution type). If the type of the sticky note is a job, the process proceeds to step S1406. Otherwise, the process proceeds to step S1426.

In step S1406, the job-supervisor association module 155 determines a user who has moved the sticky note. If the determined user is a user associated with the source area from which the sticky note has been moved (specifically, when the job is supervised by another user), the process proceeds to step S1408. If the determined user is a user associated with the destination area to which the sticky note has been moved (specifically, when the user who has moved the sticky note undertakes the job), the process proceeds to step S1414. If the determined user is a user different from the users associated with the source and destination areas (specifically, when a third party (e.g., a superior) decides a person who is responsible for the job), the process proceeds to step S1420.

In step S1408, the job-supervisor association module 155 provides a notification to the user associated with the destination area. That is, the user associated with the destination area is to be responsible for the job on the moved sticky note.

In step S1410, the job-supervisor association module 155 determines whether the sticky note has been checked by the user associated with the destination area. If the sticky note has been checked by the user associated with the destination area, the process proceeds to step S1412. Otherwise, the process ends (step S1499). As a check, for example, the job-supervisor association module 155 may notify the user of the content of the sticky note of the solution type by using a communication function or the like based on an electronic mail, a chat, or an SNS. The job-supervisor association module 155 may also notify the user of the content of the sticky note of the problem type, on which the sticky note of the solution type is based.

In step S1412, the job-supervisor association module 155 moves the target sticky note to an area for another user (an area for the user different from the author of the sticky note, which is determined in step S1402).

In step S1414, the job-supervisor association module 155 provides a notification to the user associated with the source area. That is, the user associated with the source area is removed from being in charge of the job on the moved sticky note.

In step S1416, the job-supervisor association module 155 determines whether the sticky note has been checked by the user associated with the source area. If the sticky note has been checked by the user associated with the source area, the process proceeds to step S1418. Otherwise, the process ends (step S1499).

In step S1418, the job-supervisor association module 155 moves the target sticky note to an area for another user (an area for the user different from the author of the sticky note, which is determined in step S1402).

In step S1420, the job-supervisor association module 155 provides a notification to both the users associated with the destination and source areas. That is, the user associated with the destination area is to be responsible for the job on the moved sticky note, and the user associated with the source area is removed from being in charge of the job.

In step S1422, the job-supervisor association module 155 determines whether the sticky note has been checked by both users (the users associated with the destination and source areas). If the sticky note has been checked by both users, the process proceeds to step S1424. Otherwise, the process ends (step S1499).

In step S1424, the job-supervisor association module 155 moves the target sticky note to an area for another user (an area for the user different from the author of the sticky note, which is determined in step S1402).

In step S1426, the job-supervisor association module 155 provides an alert that sticky notes of types other than “job” are not allowed to be moved to areas for different users. Such a sticky note is fundamentally attached to an area for a user who has created the sticky note. As an exception, a person in charge of the content of a job sticky note is a user associated with an area to which the sticky note is attached. An alert may be provided by, for example, notifying the user, who is to move the sticky note, of the content of the sticky note, which is of either the problem type or the normal type, by using a communication function or the like based on an electronic mail, a chat, or an SNS.

The processing of step S1406 enables an operation to be performed on a sticky note of the solution type (job type), such as forcing another user to supervise a job (called “push”) or taking responsibility for a job from another user (called “pull”).

FIGS. 15 to 26 illustrate an example of a board 1500 when “user A”, “user B”, and “user C” are participating in a meeting. Specifically, communication is performed using sticky notes within a group to which the three users belong. For example, the board 1500 may have a user interface equivalent to a communication function based on a chat or an SNS. Accordingly, each sticky note may be handled as a message. While messages are not displayed overlapping each other on a user interface such as a chat, sticky notes may be displayed overlapping each other in this exemplary embodiment. The board 1500 may be a screen on the display device of the information processing apparatus 100 or a screen on a display device of each of the electronic sticky note terminals 250.

FIG. 15 illustrates an example process according to this exemplary embodiment.

The board 1500 shows areas for users participating in the meeting, namely, a “user A” area 1510, a “user B” area 1520, and a “user C” area 1530. The board 1500 further shows a timeline 1540 with a start date and time 1542 and an end date and time 1544. The timeline 1540 may present a scheduled end date and time of the meeting (or a preserved end date and time of the conference room). In the timeline 1540, intervals may not necessarily be evenly spaced so long as the timeline 1540 represents time, with the past towards the left and the present (or the future) towards the right. That is, one of two sticky notes closer to the left end is attached earlier than the other sticky note. The example illustrated in FIG. 15 indicates that a “message 1” sticky note 1522 is attached to the board 1500 earlier than a “message 2” sticky note 1512.

The example illustrated in FIG. 15 further indicates that the user B creates the “message 1” sticky note 1522, then, the user A creates the “message 2” sticky note 1512, and then the user B creates a “problem 1” sticky note 1524. Further, presenting the “message 2” sticky note 1512 in the “user A” area 1510 and presenting the “message 1” sticky note 1522 and the “problem 1” sticky note 1524 in the “user B” area 1520 indicate that the “message 2” sticky note 1512 is created by the user A and that the “message 1” sticky note 1522 and the “problem 1” sticky note 1524 are created by the user B. Note that the users B and A originate messages (the “message 2” sticky note 1512, the “message 1” sticky note 1522, and the “problem 1” sticky note 1524). Among the messages, the user B provides markings on a message identified as a “problem” (the “problem 1” sticky note 1524).

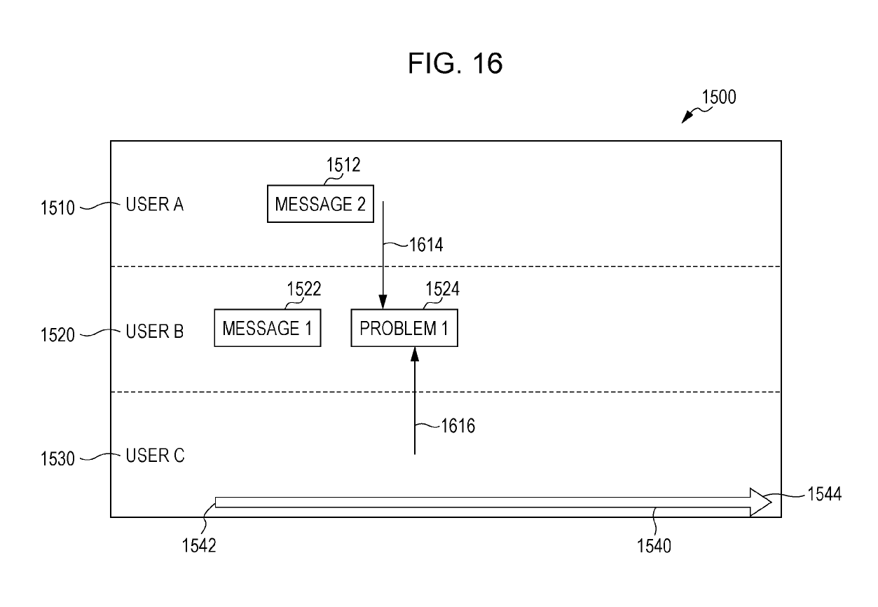

FIG. 16 illustrates an example process according to this exemplary embodiment.

Since the user A, the user B, and the user C are participating in the meeting, it is found that the users A and C have checked the problem. Thus, a check mark 1614 indicated by an arrow directed from the “user A” area 1510 to the “problem 1” sticky note 1524 is displayed, indicating that the user A has completed a check, and a check mark 1616 indicated by an arrow directed from the “user C” area 1530 to the “problem 1” sticky note 1524 is displayed, indicating that the user C has completed a check.

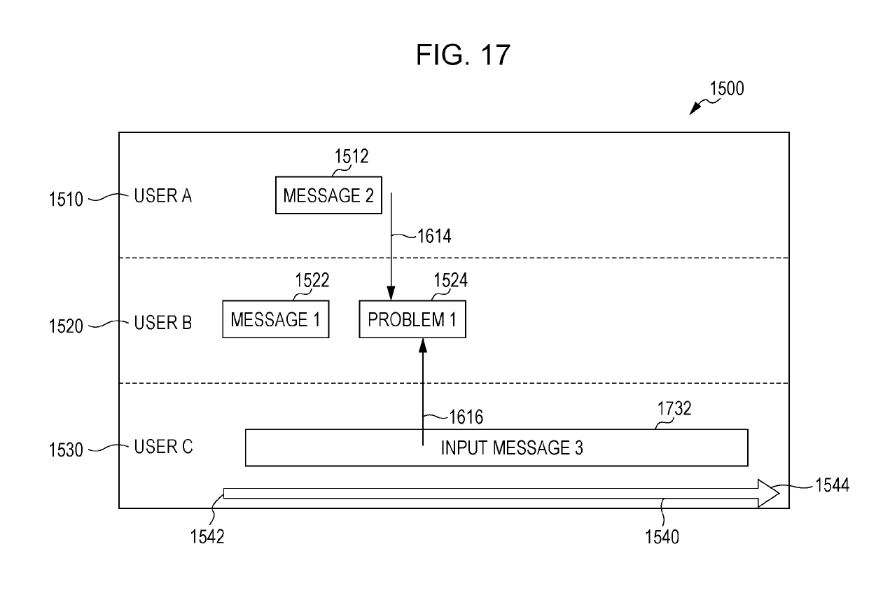

FIG. 17 illustrates an example process according to this exemplary embodiment.

After the state given in the example illustrated in FIG. 16, as the discussion about the “problem 1” sticky note 1524 or any other discussion starts and continues, the number of messages (sticky notes) increases and the board 1500 scrolls right.

To create a message about a specific sticky note, namely, the “problem 1” sticky note 1524, the “problem 1” sticky note 1524 is clicked to input a message. In the example illustrated in FIG. 17, the user C clicks the “problem 1” sticky note 1524, and thus a message sticky note input area 1732 is displayed in the “user C” area 1530 to prompt the user C to input a message in the message sticky note input area 1732.

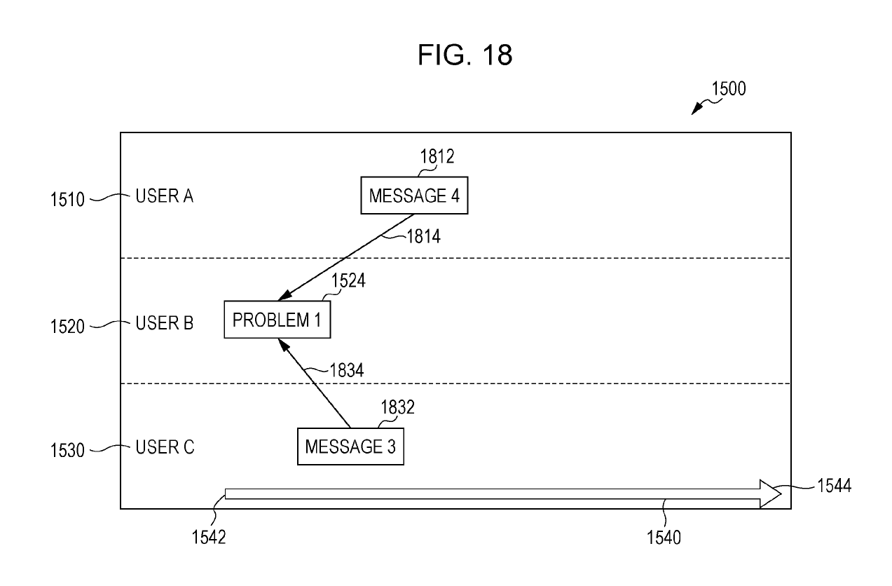

FIG. 18 illustrates an example process according to this exemplary embodiment.

The user A also creates a message (“message 4” sticky note 1812) about the “problem 1” sticky note 1524 and attaches the created message. The “problem 1” sticky note 1524 is not scrolled out but remains displayed in the area for the user B who has posted the problem (i.e., the “user B” area 1520). When a message (the “message 4” sticky note 1812 or a “message 3” sticky note 1832) is selected, the problem (the “problem 1” sticky note 1524) may be picked up. When the problem (the “problem 1” sticky note 1524) is selected, the messages responsive to the problem (i.e., the “message 4” sticky note 1812 and the “message 3” sticky note 1832) may be filtered. The term “pick up” means that a sticky note being “picked up” (in FIG. 18, the “problem 1” sticky note 1524) is displayed in a different manner from the other sticky notes (e.g., using thicker frame lines, in solid red, or in any other desired fashion). The term “filter” refers to extraction of the sticky note being “filtered” (in FIG. 18, the “message 4” sticky note 1812 and the “message 3” sticky note 1832). The other sticky notes may be deleted. Alternatively, the pick-up and filtering process may be used to draw an association arrow 1814 connecting the “problem 1” sticky note 1524 and the “message 4” sticky note 1812 and an association arrow 1834 connecting the “problem 1” sticky note 1524 and the “message 3” sticky note 1832.

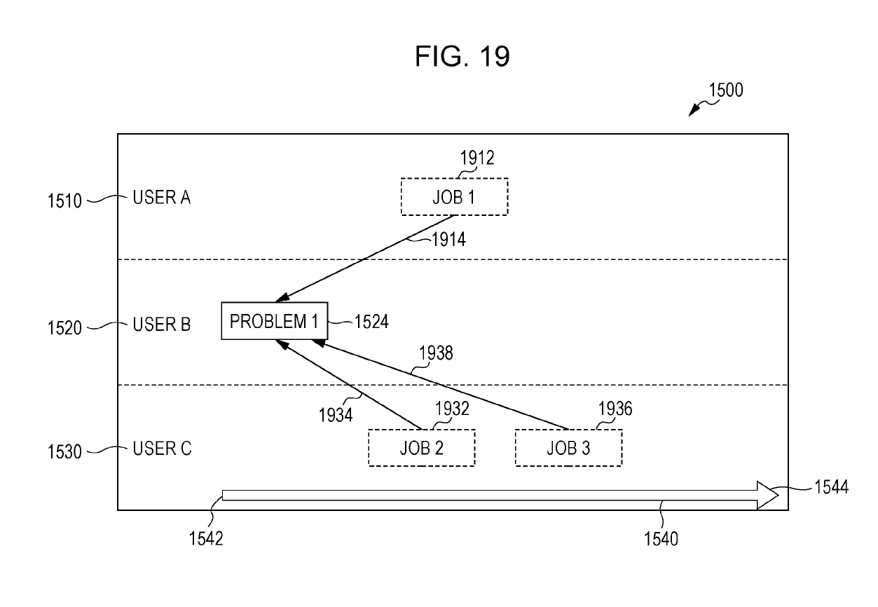

FIG. 19 illustrates an example process according to this exemplary embodiment.

The user C creates a “job 1” sticky note (uncompleted assignment) 1912, a “job 2” sticky note (uncompleted assignment) 1932, and a “job 3” sticky note (uncompleted assignment) 1936 about the “problem 1” sticky note 1524. Then, the user C, who desires the user A to supervise the “job 1” sticky note (uncompleted assignment) 1912, drops the “job 1” sticky note (uncompleted assignment) 1912 onto the “user A” area 1510 from the “user C” area 1530. The remaining two sticky notes are kept unassigned. The “message 3” sticky note 1832, which has been created, may be changed to the “job 2” sticky note (uncompleted assignment) 1932 by changing the type of the “message 3” sticky note 1832 from the normal type to the solution type (since a solution is written on the “message 3” sticky note 1832, for example). As in the example illustrated in FIG. 19, a sticky note of the solution type, which has not yet been assigned a supervisor, may be displayed in a different manner from the other sticky notes (in the example illustrated in FIG. 19, indicated by a dotted-line frame). Further, the “job 1” sticky note (uncompleted assignment) 1912, the “job 2” sticky note (uncompleted assignment) 1932, and the “job 3” sticky note (uncompleted assignment) 1936 may be respectively accompanied by an association arrow 1914, an association arrow 1934, and an association arrow 1938, which are directed to the “problem 1” sticky note 1524, as signs indicating sticky notes on which solutions to the “problem 1” sticky note 1524 are written.

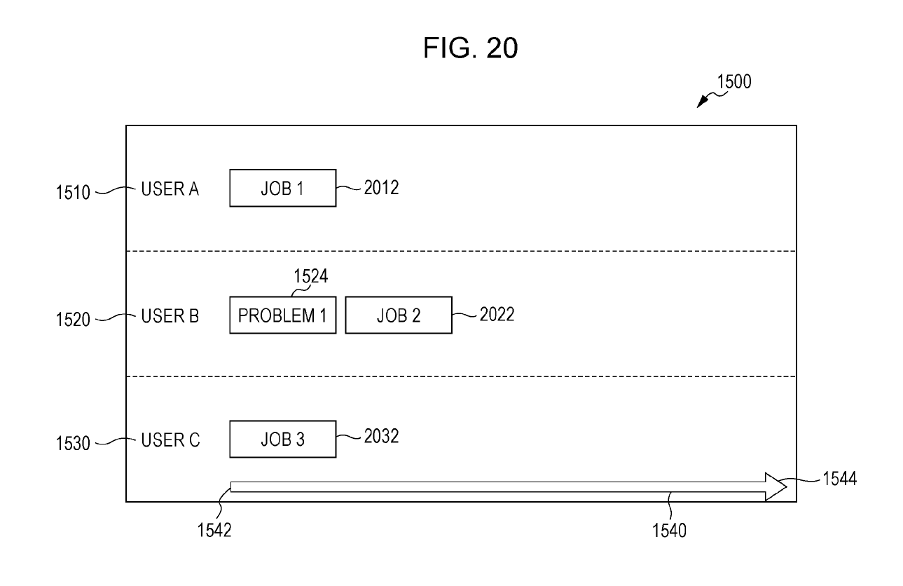

FIG. 20 illustrates an example process according to this exemplary embodiment.

After the state depicted in the example illustrated in FIG. 19, the user A undertakes the solution on the “job 1” sticky note (uncompleted assignment) 1912, the user B undertakes the solution on the “job 2” sticky note (uncompleted assignment) 1932, and the user C undertakes the solution on the “job 3” sticky note (uncompleted assignment) 1936. Thus, the “job 1” sticky note (uncompleted assignment) 1912, the “job 2” sticky note (uncompleted assignment) 1932, and the “job 3” sticky note (uncompleted assignment) 1936 are changed to sticky notes presented in a manner indicating the completion of assignment (in the example illustrated in FIG. 20, using solid-line frames) such as a “job 1” sticky note (completed assignment) 2012, a “job 2” sticky note (completed assignment) 2022, and a “job 3” sticky note (completed assignment) 2032, respectively. Thus, the problem and the jobs, which are supervised by the three users, are displayable in list view. When the “job 1” sticky note (uncompleted assignment) 1912 is dropped onto the “user A” area 1510 from the “user C” area 1530, the user A is notified of a message indicating that the user A is desired to supervise the “job 1” sticky note (uncompleted assignment) 1912, and checks the message. When the “job 2” sticky note (uncompleted assignment) 1932 is dropped onto the “user B” area 1520 from the “user C” area 1530, the user B is notified of a message indicating that the user B is desired to supervise the “job 2” sticky note (uncompleted assignment) 1932, and checks the message.

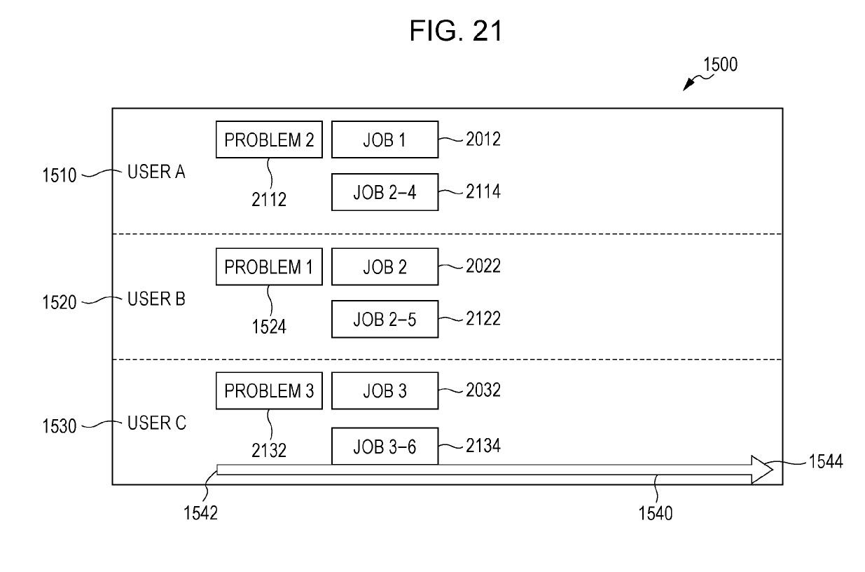

FIG. 21 illustrates an example process according to this exemplary embodiment.

When the number of sticky notes of the problem type and the number of sticky notes of the solution type increase, as in the example illustrated in FIG. 21, sticky notes, each of which is associated with a supervisor, are each attached to the area for the corresponding supervisor. When each of the solutions is completed, the sticky note may be deleted from the board 1500.

The example illustrated in FIG. 21 indicates that the “user A” area 1510 include a “problem 2” sticky note 2112, the “job 1” sticky note (completed assignment) 2012, and a “job 2-4” sticky note 2114, the “user B” area 1520 includes the “problem 1” sticky note 1524, the “job 2” sticky note (completed assignment) 2022, and a “job 2-5” sticky note 2122, and the “user C” area 1530 includes a “problem 3” sticky note 2132, the “job 3” sticky note (completed assignment) 2032, and a “job 3-6” sticky note 2134. Alternatively, a sticky note of the problem type and a sticky note of the solution type corresponding to the sticky note of the problem type may be attached in association with each other. That is, sticky notes may be displayed in such a manner that a problem and a solution to the problem are associated with each other.

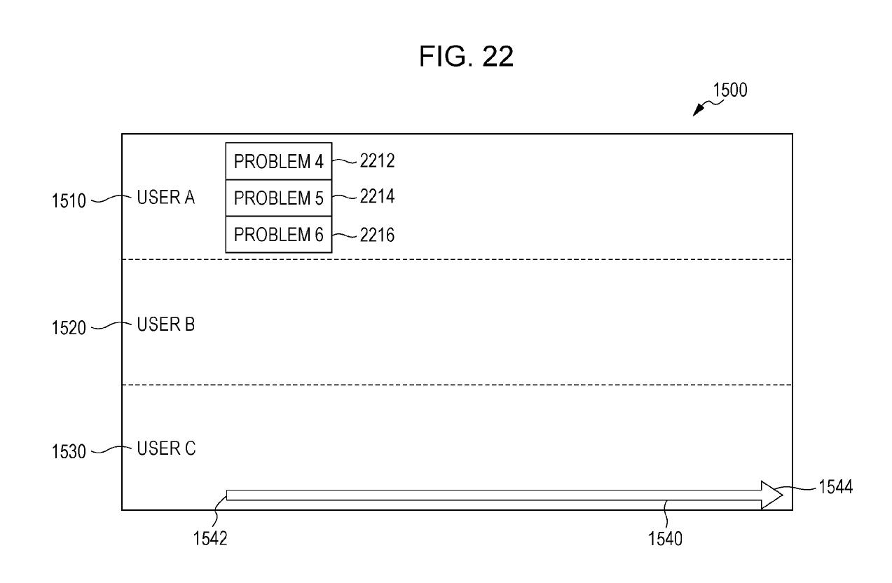

FIG. 22 illustrates an example process according to this exemplary embodiment.

If the number of sticky notes of the problem type created (posted) by the user A increases so that not all the sticky notes of the problem type are displayable in the “user A” area 1510, the “user A” area 1510 may be deployed to allow the sticky notes of the problem type to be viewed in order from old to new. The term “deploy”, as used here, refers to the display of a plurality of sticky notes, which are displayed overlapping each other, in the “user A” area 1510 in order of creation (ascending order). The sticky notes of the other types (i.e., the solution type and the normal type) may be deleted from within the “user A” area 1510. The example illustrated in FIG. 22 indicates the state of the “user A” area 1510 after deployment, in which a “problem 4” sticky note 2212, a “problem 5” sticky note 2214, and a “problem 6” sticky note 2216 are displayed as a list in order of creation.

Also for solutions (or jobs), when the number of sticky notes of the solution type supervised by the user A increases so that not all the sticky notes of the solution type are displayable in the “user A” area 1510, the “user A” area 1510 may be deployed to allow the sticky notes of the solution type to be viewed in order from old to new.

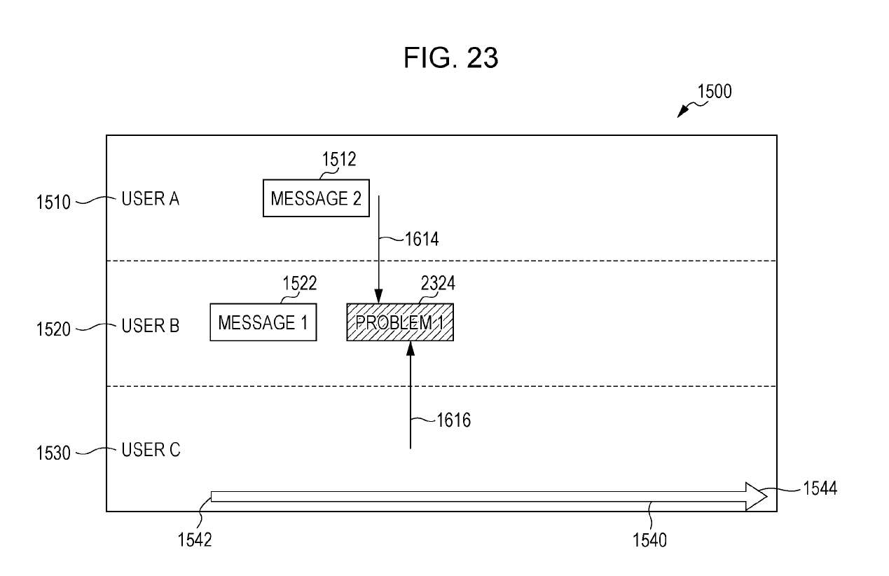

FIG. 23 illustrates an example process according to this exemplary embodiment.

Upon detection of a click on a sticky note of the problem type, the state of the board 1500 may be returned to that obtained at the time point when the problem is posted (the time point when the sticky note is attached). The example illustrated in FIG. 23 indicates a state after a “problem 1” sticky note (selected) 2324 among a plurality of sticky notes of the problem type displayed in list form is clicked in accordance with an operation performed by a user. That is, the sticky notes and signs displayed at the time point when the “problem 1” sticky note (selected) 2324 is created, namely, the “message 2” sticky note 1512, the “message 1” sticky note 1522, the check mark 1614, and the check mark 1616, are displayed.

Also for solutions (or jobs), upon detection of a click on a sticky note of the solution type, the state of the board 1500 may be returned to the previous state. The previous state may be the state obtained when the clicked sticky note is generated (beginning) or the state obtained when the solution on the sticky note is completed (end).

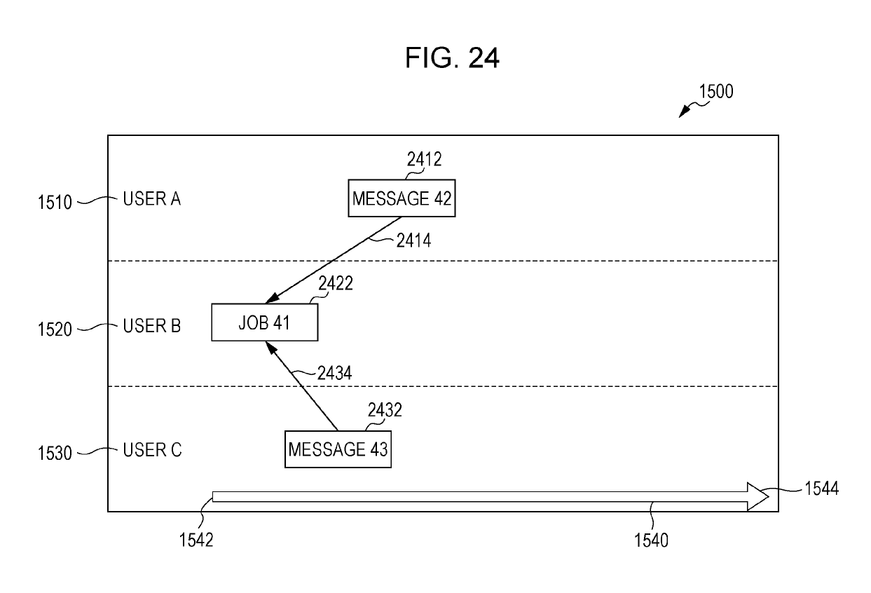

FIG. 24 illustrates an example process according to this exemplary embodiment.

A sticky note (message) about a sticky note of the problem type may be generated.

Also for solutions (or jobs), a sticky note (message) about a sticky note of the solution type may be generated and referenced. The example illustrated in FIG. 24 indicates that the users A and C generate a “message 42” sticky note 2412 and a “message 43” sticky note 2432 about a “job 41” sticky note 2422, respectively. In the illustrated example, an association arrow 2414 indicates that the “message 42” sticky note 2412 about the “job 41” sticky note 2422 has been generated. An association arrow 2434 indicates that the “message 43” sticky note 2432 about the “job 41” sticky note 2422 has been generated.

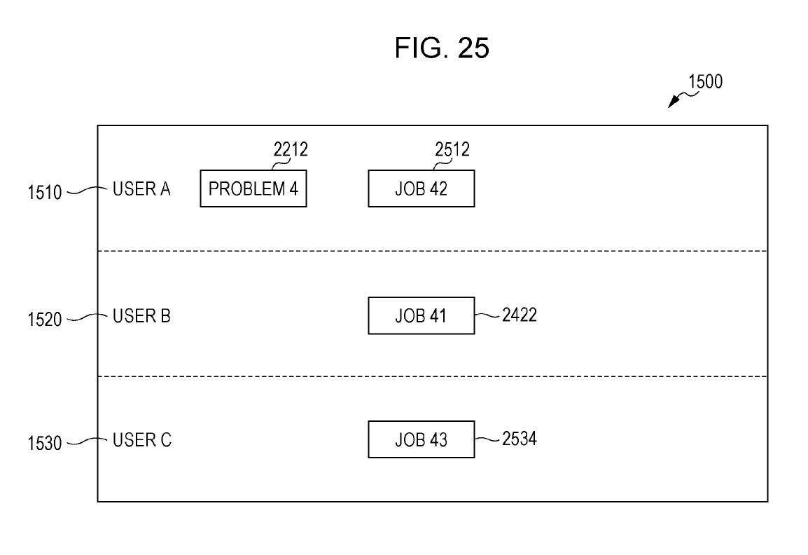

FIG. 25 illustrates an example process according to this exemplary embodiment.

A sticky note indicating a problem may be referenced (filtered). The term “referencing”, as used here, refers to filtering, and a sticky note associated with a sticky note being referenced is displayed. When the “problem 4” sticky note 2212 is referenced in accordance with an operation performed by a user, sticky notes generated in association with the “problem 4” sticky note 2212, namely, a “job 42” sticky note 2512, the “job 41” sticky note 2422, and a “job 43” sticky note 2534, are displayed.

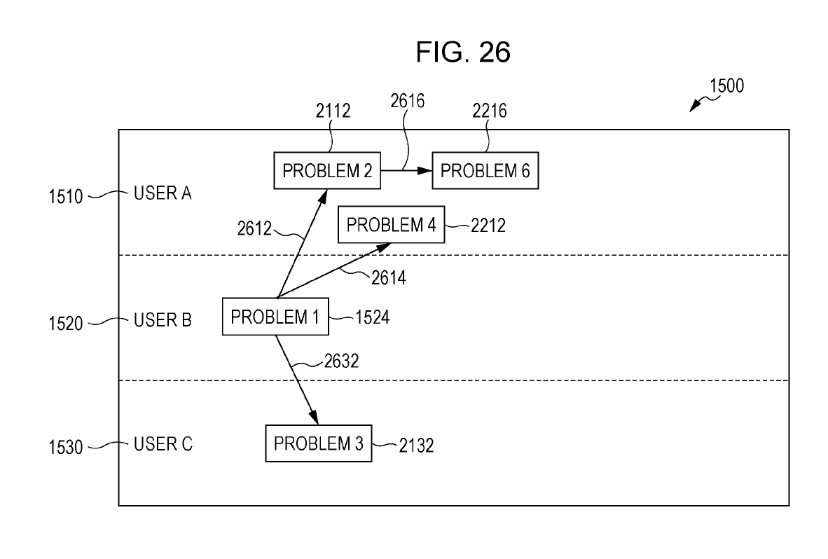

FIG. 26 illustrates an example process according to this exemplary embodiment.

As described with reference to the example illustrated in FIG. 10, sticky notes of the problem type and sticky notes of the solution type form a tree structure. That is, each sticky note of the problem type or the solution type is a root or is generated as a child of a root sticky note of the problem type or the solution type.

The example illustrated in FIG. 26 indicates a problem view. The problem view is a view in which sticky notes of the problem type are extracted from a tree structure with nodes representing sticky notes of the problem type and sticky notes of the solution type and are displayed as a tree structure. The “problem 1” sticky note 1524 is a root, with the children being the “problem 2” sticky note 2112, the “problem 3” sticky note 2132, and the “problem 4” sticky note 2212, and the “problem 6” sticky note 2216 resides as a child of the “problem 2” sticky note 2112. An association arrow 2612 indicates that the “problem 2” sticky note 2112 is subordinate to the “problem 1” sticky note 1524. An association arrow 2632 indicates that the “problem 3” sticky note 2132 is subordinate to the “problem 1” sticky note 1524. An association arrow 2614 indicates that the “problem 4” sticky note 2212 is subordinate to the “problem 1” sticky note 1524. An association arrow 2616 indicates that the “problem 6” sticky note 2216 is subordinate to the “problem 2” sticky note 2112.

Also for solutions (or jobs), a solution view may be displayed. That is, sticky notes of the solution type are extracted from a tree structure with nodes representing sticky notes of the problem type and sticky notes of the solution type, and are displayed as a tree structure.

When a sticky note is generated, the sticky note is displayed on the board 1500. The sticky note is fundamentally attached to an area for a user who has generated the sticky note. Note that a sticky note of the solution type is attached to an area for a supervisor of a solution (or job) written on the sticky note. When the solution (or job) is completed, the sticky note indicating the solution is deleted from the board 1500. The determination of whether a solution (or job) is completed may be performed by referring to the “end date and time” column 950 of the job sticky note management table 900. When a sticky note is to be deleted, the display of the sticky note on the board 1500 is deleted, but the sticky note itself may not be deleted from within the job management module 170 and may be displayed again.

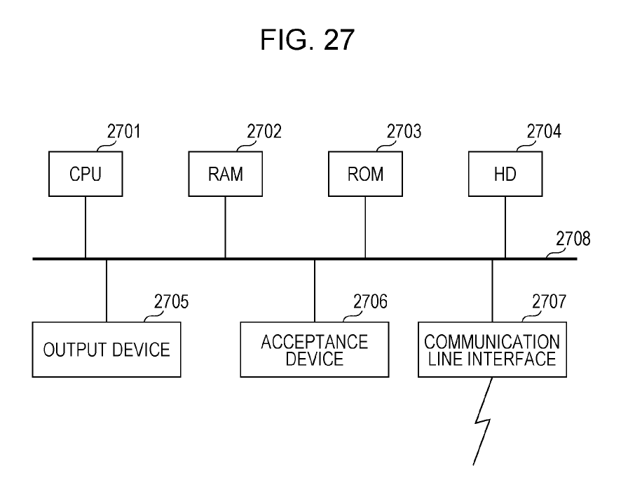

As illustrated in FIG. 27, the hardware configuration of a computer that executes a program according to this exemplary embodiment is a typical computer, namely, a computer that may serve as a personal computer or a server. That is, as a specific example, a CPU 2701 is used as a processing unit (computation unit), and a RAM 2702, a read-only memory (ROM) 2703, and a hard disk drive (HD) 2704 are used as storage devices. The HD 2704 may be implemented as, for example, a hard disk or a solid state drive (SSD). The computer includes the CPU 2701, the RAM 2702, the ROM 2703, the HD 2704, an acceptance device 2706, an output device 2705, a communication line interface 2707, and a bus 2708. The CPU 2701 executes a program implementing the sticky note acceptance module 105, the type processing module 110, the type check module 115, the type assignment module 120, the sticky note management module 125, the sticky note editing module 130, the sticky note presentation module 135, the problem/job sticky note presentation module 140, the problem/job management module 145, the problem-job association module 150, the job-supervisor association module 155, the problem/job management processing module 160, and so on. The RAM 2702 stores the program and data. The ROM 2703 stores a program or the like for starting the computer. The HD 2704 is an auxiliary storage device (such as a flash memory) having functions serving as the meeting/board/sticky note information storage module 165 and the job management module 170. The acceptance device 2706 accepts data in accordance with operations (including gestures, voice, lines of sight, and so on) performed by a user on a keyboard, a mouse, a touch screen, a microphone, a camera (including a line-of-sight detection camera), or the like. Examples of the output device 2705 include a cathode ray tube (CRT), a liquid crystal display, and one or more speakers. The communication line interface 2707 is connected to a communication network, and examples of the communication line interface 2707 include a network interface card. The components of the computer described above are connected to one another via the bus 2708 to exchange data. A plurality of computers, each having the configuration described above, may be interconnected via a network.

Elements of the exemplary embodiment described above that are implemented by a computer program are implemented by causing a system having the hardware configuration illustrated in FIG. 27 to read a computer program, which is software, and the software and hardware resources to cooperate with each other to realize the exemplary embodiment described above.

The hardware configuration illustrated in FIG. 27 is one example configuration, and this exemplary embodiment is not limited to the configuration illustrated in FIG. 27 and may employ a configuration in which the modules described in this exemplary embodiment are executable. For example, some of the modules may be implemented as dedicated hardware (such as an application specific integrated circuit (ASIC)). Further, some of the modules may be located in an external system and may be connected to the system illustrated in FIG. 27 via a communication line. In addition, a plurality of systems, each of which has the configuration illustrated in FIG. 27, may be connected to each other via a communication line and may operate in cooperation with each other. Additionally, the modules may be incorporated in, in particular, a personal computer or any other device such as a mobile information communication device (examples of which include a mobile phone, a smartphone, a mobile device, and a wearable computer), an information home appliance, a robot, a copying machine, a facsimile machine, a scanner, a printer, or a multifunction device (an image processing device having two or more of the functions of a scanner, a printer, a copying machine, a facsimile machine, and other devices).

The program described above may be stored in a recording medium and the recording medium may be provided. Alternatively, the program may be provided via a communication means. In this case, for example, the program described above may be implemented as a “computer-readable recording medium storing the program”.

The term “computer-readable recording medium storing the program” refers to a recording medium readable by a computer and having the program recorded thereon, which is used for installing and executing the program, distributing the program, or any other purpose.

Examples of the recording medium include digital versatile discs (DVDs), such as discs based on standards created by the DVD Forum, namely, DVD-R, DVD-RW, and DVD-RAM, and discs based on standards created by the DVD+RW Alliance, namely, DVD+R and DVD+RW, compact discs (CDs), such as a compact disc read-only memory (CD-ROM), a CD-Recordable (CD-R) disc, and a CD-Rewritable (CD-RW) disc, Blu-ray Disc (registered trademark), a magneto-optical (MO) disk, a flexible disk (FD), a magnetic tape, a hard disk, a ROM, an electrically erasable programmable read-only memory (EEPROM (registered trademark)), a flash memory, a RAM, and a secure digital (SD) memory card.

All or part of the program described above may be recorded on the recording medium described above for storage or distribution, for example. Alternatively, all or part of the program described above may be transmitted via communication by using a transmission medium such as a wired network, a wireless communication network, or a combination thereof that is used for a communication architecture such as a local area network (LAN), a metropolitan area network (MAN), a wide area network (WAN), the Internet, an intranet, or an extranet, or may be carried on carrier waves.

Additionally, the program described above may be part or all of another program, or may be recorded on a recording medium together with an individual program. Alternatively, the program may be divided into pieces which are recorded on a plurality of recording media. Moreover, the program may be recorded in any form that is restorable, such as in compressed or encrypted form.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a type assignment unit that assigns to a sticky note attachable to a board a problem type indicating that content of the sticky note is a problem.

2. The information processing apparatus according to claim 1, wherein the type assignment unit further assigns to a sticky note attachable to the board a solution type indicating that content of the sticky note is a solution to the problem.

3. The information processing apparatus according to claim 2, wherein the type assignment unit further assigns to a sticky note attachable to the board a normal type indicating that content of the sticky note is different from the problem and the solution.

4. The information processing apparatus according to claim 2, wherein one or more sticky notes of the problem type and one or more sticky notes of the solution type form a tree structure.

5. The information processing apparatus according to claim 3, wherein one or more sticky notes of the problem type and one or more sticky notes of the solution type form a tree structure.

6. The information processing apparatus according to claim 1, further comprising
a presentation unit that presents, on the board, a sign for a sticky note of the problem type, which is attached to the board, when a user participating in a meeting during which the board is used has an area on the board, the sign indicating that the user has checked the sticky note of the problem type.

7. The information processing apparatus according to claim 6, wherein a plurality of sticky notes are attached to the board in chronological order, and
wherein the presentation unit presents signs for the plurality of sticky notes in accordance with chronological order.

8. The information processing apparatus according to claim 1, wherein when a sticky note attached to the board has a solution type indicating a solution, in response to movement of the sticky note to an area defined for a user on the board, the type assignment unit causes the user to supervise a solution written on the sticky note.

9. The information processing apparatus according to claim 8, wherein in response to movement of the sticky note to an area defined for a second user different from the user, the type assignment unit obtains permission from the second user.

10. A non-transitory computer readable medium storing a program causing a computer to execute a process for information processing, the process comprising:
assigning to a sticky note attachable to a board a problem type indicating that content of the sticky note is a problem.

11. An information processing apparatus comprising:
type assignment means for assigning to a sticky note attachable to a board a problem type indicating that content of the sticky note is a problem.
